(19) United States
(12) Patent Application Publication
(10) Pub. No.: US 2006/0112001 A1
(43) Pub. Date: May 25, 2006

(54) Method and apparatus for online platforms for enabling a professional trader to provide a plurality of clients with real-time market timing guidance

(75) Inventor: Reynaldo J. Perales, San Antonio, TX (US)

Correspondence Address: Charles W. Hanor, P.C., PO Box 91319, San Antonio, TX, 78209, US

(73) Assignee: STS Technology Systems LLC

(21) Appl. No.: 10/997,217

(22) Filed: Nov. 24, 2004

(51) Int. Cl. G06Q 40/00; G06F 7/00; G06F 17/00

(52) U.S. Cl. 705/37; 707/100

(57) ABSTRACT

A platform is provided that enables a professional trader to relay information for educational purposes about buying and selling assets using a color system (red, green, and yellow) represented by a small sphere located on the user's desktop. A central server is used to send information over the Internet necessary to change the color of the spheres. The platform disclosed herein also provides an instant messaging interface, a streaming voice interface, and intraday price fluctuation charts.

### FIELD OF THE INVENTION

This invention relates to online platforms for enabling a professional trader to provide a plurality of clients with real-time market timing guidance.

### BACKGROUND OF THE INVENTION

The advent of online brokerages has spawned a popular interest in day trading. Many professionals offer live classes to teach prospective day traders the favored analytical techniques of the profession. After these novice traders have completed their classes, the professional's guidance and assistance typically comes to an end. Typically, such novice traders thereafter fend for themselves by purchasing software packages that provide intraday price fluctuation charts filled with technical information on the price movements of various exchange-traded assets.

### SUMMARY OF THE INVENTION

There is a need for an online platform that enables a professional trader to provide a plurality of clients with real-time market timing guidance. To meet this need, the present application discloses a platform is provided that enables a professional trader to relay information for educational purposes about buying and selling assets using a color system (red, green, and yellow) represented by a small sphere located on the user's desktop. A central server is used to send information over the Internet necessary to change the color of the spheres. To further meet this need, the platform disclosed herein also provides an instant messaging interface, a streaming voice interface, and intraday and/or longer range price fluctuation charts. The invention, however, is not limited to color-coded balls or any other particular visual representation or sensory stimulus.

At a broad conceptual level, an apparatus is provided enabling a trader to provide a plurality of clients with market timing guidance. The apparatus comprises a host computer software module that provides a limited set of predetermined and selectable buy and sell signals (preferably no more than ten). The host computer software module enables the trader to select one of the predetermined and selectable buy and sell signals to communicate a buy or sell recommendation on one or more assets to the plurality of clients. The apparatus also comprises a computer software module for each of said plurality of clients. Each client computer software module receives the buy and sell recommendations from the host computer software module over a computer network. In near-instantaneous fashion, the plurality of client computer software modules simultaneously and instantly communicate the trader's selected buy and sell signals to the plurality of clients.

In one embodiment, the set of predetermined and selectable buy and sell signals comprises green and red colored buy and sell signals. In another embodiment, each client computer software module displays the trader's selected buy and sell signals with a windowless control that defines the display area. In yet another embodiment, the client computer software module displays the trader's selected buy and sell signals through a semi-transparent graphical user interface adapted to remain in the forefront of a computer desktop display when another computer application is active.

In more detailed embodiments, the apparatus also provides intraday price fluctuation charts about the traded asset, whereby the combined display of intraday price fluctuation information of the asset together with the trader's selected buy and sell signals facilitates client education about the professional trader's market timing strategies. In other more detailed embodiments, the apparatus also provides instant messaging and/or streaming voice data interfaces that enable the professional trader to send and receive instant messages and/or voice messages to and from the clients.

In an alternative embodiment, the host computer software module provides a predetermined set of risk-categorized trading signals. The host computer software module communicates information identifying the professional trader's individual trades of an asset together with corresponding risk-categorized trading signals that characterize the risk of the professional trader's trades. Each client computer software module receives and instantly displays the trade information and corresponding risk-categorized trading signals from the trader computer software module.

Put yet another way, an asset-price analysis system is provided. The system comprises a computer application that communicates with an information network and displays one of a predetermined set of selectable signals that reflect the analyst's risk assessment of trading the asset. The system also displays first and second windows. The first window comprises an instant messaging interface for sending and receiving messages from an analyst regarding the advisability of trading an asset. The second window provides intraday price fluctuation information about the asset. In a more detailed embodiment, the predetermined set of selectable signals comprise color-coded objects whose colors characterize the risk of buying or selling the asset.

Also, various methods are described for providing a plurality of clients with market timing guidance. A first method comprises providing a professional trader with a host computer software module that includes a set of predetermined and selectable buy and sell signals. Each of said plurality of clients are then provided with client computer software modules operable to receive information from said host computer software module over a computer network. The trader then selects one of said predetermined and selectable buy and sell signals and communicates a buy or sell recommendation on one or more assets to the plurality of clients. The client computer software modules then simultaneously and near-instantaneously display the professional trader's buy and sell signals.

A second method comprises providing a professional trader with an asset trading computer software module that enables the professional trader submit an order to trade an exchange-traded asset. The professional trader's host computer software module then automatically retrieves information identifying open or closed trade orders made by the professional trader through said asset trading computer software module. The host computer software module then communicates a predetermined set of risk-categorized trading signals that characterize the risk of the professional trader's trades. The client computer software modules then simultaneously and nearly-instantaneously display the professional trader's open or closed trade orders together with the corresponding risk-categorized trading signals.

A method is also disclosed for providing a client with an advisor-assisted platform for monitoring intraday fluctuations in market prices of an asset, thereby assisting the client in making intraday trades. The method comprises providing the client with a computer software module that displays intraday price fluctuation information about the asset together with an instant messaging interface for sending and receiving messages to and from an advisor. The advisor is also provided with a computer software module that displays intraday price fluctuation information about the same asset monitored by the client and provides the advisor with a messaging interface for sending and receiving messages to and from the client. Then, streaming data about the price of an asset or index of assets is provided to the client's and advisor's computer software modules.

These and other suitable applications, modifications, and enhancements of the invention will be readily apparent to those skilled in the art from the following detailed description taken in conjunction with the annexed sheets of drawings, which illustrate the invention.

### BRIEF DESCRIPTION OF THE DRAWINGS

FIG. 1 is a block diagram of one embodiment of a computer-based platform for enabling a professional trader to provide a plurality of clients with market timing guidance.

FIG. 2 is a flow chart of one embodiment of a method for providing a plurality of clients with market timing guidance.

FIG. 3 illustrates an embodiment of a trade guidance signaling device, together with its user control and online status menus, on a client computer display.

FIG. 4 depicts a collection of color-coded embodiments of the trade guidance signaling device of FIG. 3.

FIG. 5 illustrates one embodiment of a screen display of a first tab of an option window triggered by selecting the option button of the trade guidance signaling device of FIG. 3.

FIG. 6 illustrates one embodiment of a screen display of a second tab of an option window triggered by selecting the option button of the trade guidance signaling device of FIG. 3.

FIG. 7 illustrates one embodiment of a chat room interface enabled by selecting the “Log in” button of the user control menu of FIG. 3.

FIG. 8 illustrates one embodiment of an intraday price fluctuation chart which, when used in combination with a trade guidance signaling device, facilitates client education.

FIG. 9 illustrates one embodiment of a screen display of a first tab of a host computer interface for enabling a professional trader to provide a plurality of clients with market timing guidance.

FIG. 10 illustrates one embodiment of a screen display of a second tab of a host computer interface for enabling a professional trader to provide a plurality of clients with market timing guidance.

FIG. 11 illustrates three embodiments of a trade guidance signaling device on a client computer display.

### DETAILED DESCRIPTION

Before the subject invention is described further, it is to be understood that the invention is not limited to the particular embodiments of the invention described below. Many modifications may be made to adapt a particular situation, composition, process, process step or steps, to the objective, spirit and scope of the present invention. Therefore, it should be understood that, unless otherwise specified, this invention is not to be limited to the specific details shown and described herein, and all such modifications are intended to be within the scope of the claims made herein.

It is also to be understood that the terminology employed in the Summary of the Invention and Detailed Description sections of this application is for the purpose of describing particular embodiments. Unless the context clearly demonstrates otherwise, is not intended to be limiting. In this specification and the appended claims, the singular forms “a,” “an” and “the” include plural reference unless the context clearly dictates otherwise. Conversely, it is contemplated that the claims may be drafted to exclude any optional element or be further limited using exclusive terminology as “solely,” “only” and the like in connection with the recitation of claim elements or by use of a “negative” limitation. It is also contemplated that any optional feature of the inventive variations described herein may be set forth and claimed independently, or in combination with any one or more of the features described herein.

As used in this application, the terms “computer” and “software” are used in their conventional senses. A computer has a processor, computer memory (such as volatile random-access memory, flash memory, hard drives, floppy drives, compact disk drives, optical drives), one or more input devices (such as computer mice, keyboards, remote control devices, scanners, communication ports, and/or touch screens), and one or more output devices (such as computer monitors, speakers, printers, communication ports, and/or other peripherals). Computers encompass desktops, laptops, personal digital assistants, processor- and memory-based cell phones, and, increasingly, home entertainment devices such as television sets. Software comprises programs, routines, and symbolic languages stored in the computer's memory to control the functioning of the computer's hardware and direct its operation. A computer software program, module, or application is, in a sense, a configuration of the computer hardware that enables it to perform a function or application. It will be understood that the software programs, modules, and applications described herein covers both fully integrated self-contained lists of instructions, and combinations or packages of multiple independent applications.

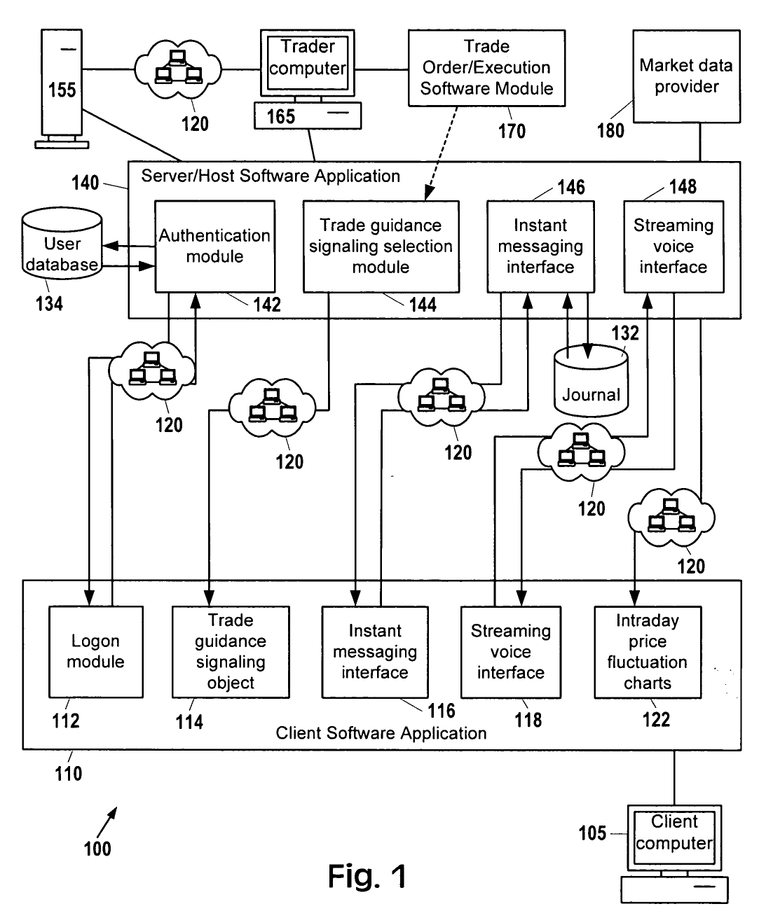

FIG. 1 is a block diagram of one embodiment of a computer-based platform 100 for enabling a professional trader to provide a plurality of clients with market timing guidance. In its most basic form, the platform 100 comprises a server/host software application 140 linked by a network 120 to a client software application 110. Each of the professional trader's clients is provided with a copy of the client software application 110 to install on their respective computers 105. With this platform 100, the professional trader is able to use the same central server/host software application 140 to simultaneously communicate with and provide guidance to multiple clients through the client software applications 110 installed on their computers 105.

In a more preferred embodiment, there are at least two separately installed server/host software applications 140, although for convenience, FIG. 1 depicts only one of them. The first server/host computer application 140 is located on the professional trader's computer 165. It acts as a remote controller of a second server/host computer application 140 located on a remote server 155. The second server/host computer application 140 routes information between the first server/host computer application and the client software applications 110. It should be understood that the server 155 may consist of either a single or, for added performance, multiple computers running the server/host computer application 140.

The server/host computer application 140 comprises a trade guidance signal selection module 144, and the client computer application 110 comprises a corresponding trade guidance signaling object 114. The professional trader uses the trade guidance signal selection module 144 to succinctly broadcast trade guidance signals to his clients. Each client's corresponding trade guidance signaling object 114, which may for example take the form of a color-coded representation of a ball on the client's computer desktop, communicates the broadcast signal to the client.

The trading guidance may take the form of recommendations or risk characterizations of buying or selling a given exchange-traded asset (such as a stock, bond, fund, option, derivative, or futures contract). The trading guidance may also include declarative and evaluative information of recommended or already-executed or ordered trades. For example, a professional trader who wants his clients to study his own trading techniques can communicate declarative information about a trade that the trader just ordered or executed, together with the trader's own evaluation, or some algorithmically-derived objective evaluation, of the trade. In another example, a professional trader who wants to provide trading recommendations can communicate declarative information about the current price of a futures contract together with evaluative information about the wisdom of making a particular trade of that contract.

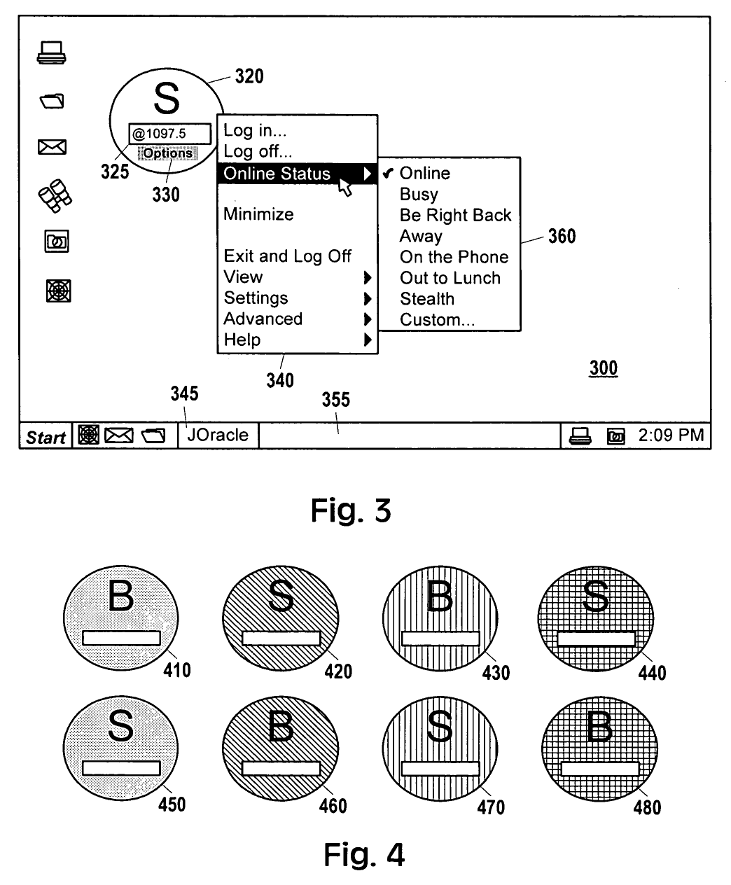

FIG. 3 illustrates a presently preferred embodiment of a trade guidance signaling object 114 that takes the form of a color-coded ball 320 on the client's computer desktop display 300. The color-coded ball 320 prominently displays the capital letter “S” for sell or short sell, the letter “B” for buy, or a question mark “?” for neither. The color-coded ball 320 also takes on gray, green, yellow, and red color representations 410-480 as illustrated in FIG. 4 (which uses long-established trademark shading conventions for depicting color).

The trader establishes the meaning of the color signals according to his or her own prerogative. In one embodiment, the colors green, yellow, and red represent highly, moderately, and weakly recommended trades. In another embodiment, the colors green, yellow, and red represent low, moderate, and high risk characterizations of a trade. In a third embodiment, blinking green alerts the client to prepare to stake a position in the market, either by buying (“B”) or short selling (“S”) a futures contract. Solid green recommends the client immediately enter the market (i.e., make the purchase or short sale trade). Yellow means that the optimal time for entering the market has passed, and that the recommended trade activity now entails more risk or is otherwise less attractive. Red recommends that the client exit the position (i.e., if “S”, then cover the short, or if “B” to sell what had been purchased). The trader may base his recommendations and risk characterizations on objective technical analysis, subjective intuition, or some combination of both.

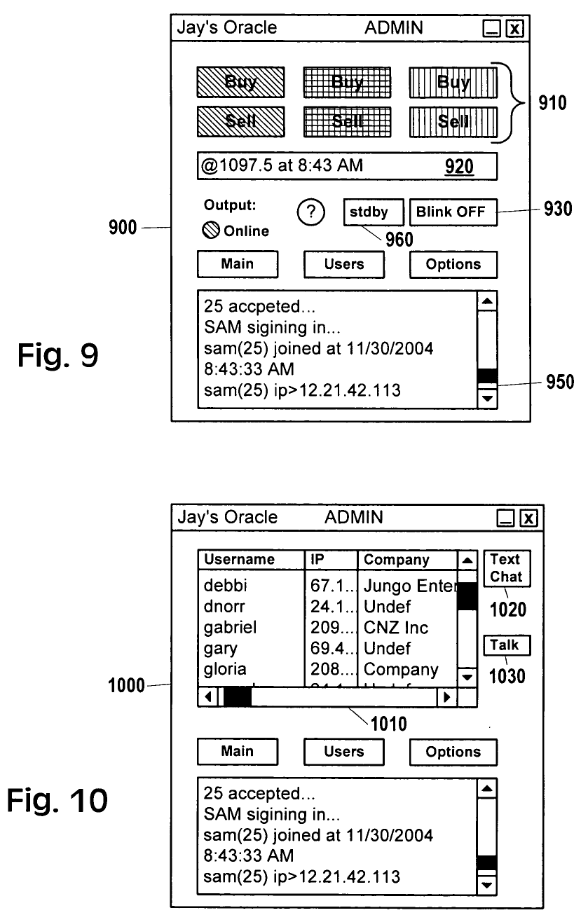

FIG. 9 illustrates one embodiment of the trade guidance signal selection module 144 of FIG. 1. The signal selection module 144 takes the form of a window 900 that presents a set of predetermined and mouse-click-selectable color-coded (green, yellow, red) buy and sell signals 910. The clients' color coded-balls 320 are caused to take on a color representation and message (e.g., “B” or “S”) that corresponds with a selected signal 910. The window 900 also provides a text message entry box 920 for entering declarative information, such as the current price of the asset, the price at which the trader himself entered the market, the number of shares or contracts traded, and/or the time at which the recommendation or trade order was entered or executed. Information entered into box 920 is communicated to the client's trade guidance signaling object 114 and displayed in a text message display box 325 (FIG. 3) superimposed on the color-coded ball 320. Selecting a toggle button 930 causes the clients' color-coded balls 114 to toggle between blinking and not blinking. The standby button 960 enables the trader to indicate the absence of any current recommendation. When the standby button 960 is selected, the clients' color-coded balls 320 turn gray and display a “?” in place of the “S” depicted in FIG. 3.

Preferably, the client software application 110 is configured to start running automatically during the client computer's boot up routine. During the boot up routine, the color-coded ball 320 appears on the client's desktop, ready to communicate the trader's color-coded signals and declarative information. The client software application 110 uses a windowless control to define the display area of the color-coded ball 320. The ball 320 can be dragged to any location on the computer desktop display 300 using mouse controls. The ball 320 is adapted to remain in the forefront of the computer desktop display 300 when other computer application windows are active. The ball 320 may also optionally take on a client-selectable degree of transparency, so that it does not completely obstruct the client's view or use of another active computer application window.

Of course, it should be understood that unless otherwise specified, the claims are not limited to color-coded balls or any other particular visual representation. Alternative trade guidance signaling objects may take on other computer-driven perceptible forms and use any type of sensory stimulus (e.g., visual, audible, tactile, olfactory, and gustatory stimuli) or combination thereof designed to attract the client's attention.

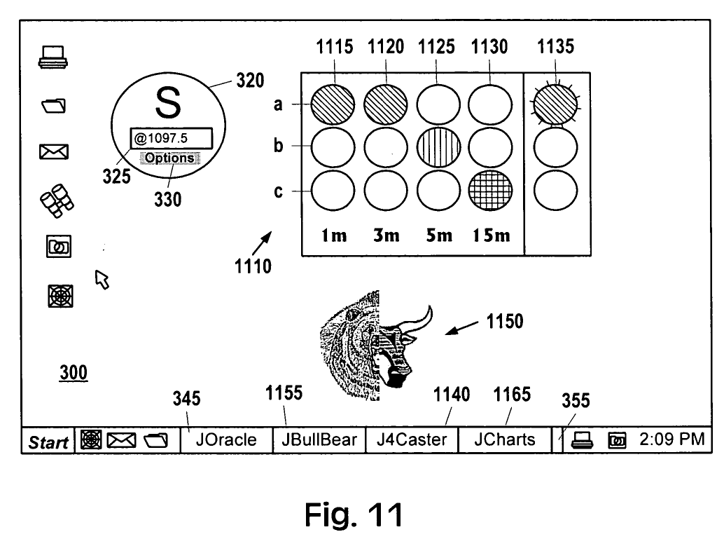

For example, FIG. 11 illustrates two additional embodiments of a trade guidance signaling object 114 on a client computer display 300. A technical convergence indicator 1110 provides a plurality of technical trading signal sets 1115, 1120, 1125, 1130, and 1135, in a form resembling several side-by-side traffic light signals with green (a), yellow (b), and red (c) colored lights. The trading signal sets 1115, 1120, 1125, and 1130 provide technical trading guidance based on different time frames—for example, guidance based on technical analyses of 1 minute, 3 minute, 5 minute, and 15 minute charts. If all of the trading signal sets 1115, 1120, 1125, and 1130 provide the same trading guidance signal (e.g., green), then the trading signal convergence set 1135 will display the same trading guidance signal. If the different trading signal sets 1115, 1120, 1125, and 1130 are progressively trending toward a common trading guidance signal, then the trading signal convergence set 1135 may begin blinking that trading guidance signal, as illustrated by the flashing signal 1135a of FIG. 11.

FIG. 11 also illustrates a bull-bear trading signal set 1150 displays either a bull or a bear on the client's desktop 300 representative of a trading recommendation. In yet another embodiment, not shown in FIG. 11, the trader instantly communicates selected ones of a predetermined set of audio signals to his clients. The predetermined set of audio signals may comprise, for example, the sound of a yelp (“Hoowah!”) or clapping to provoke the client to buy a futures contract or other asset; or the expression “dive, dive, dive!” to provoke the client to cover his or her open positions in the market.

In one embodiment, various combinations of trading guidance signal sets (e.g., the signal sets illustrated by numerals 320, 1110, and 1150) are provided to clients on a subscription package basis. Preferably, each trading guidance signal set corresponds with, and is marketed toward clients with, a particular level of risk tolerance or a particular type of trading style (e.g., fast intraday trading styles versus more patient, longer term trading styles). For example, the technical convergence indicator 1110 provides guidance to clients with a low level of risk tolerance—persons who would rather wait to make a trade until they detect a convergence of a combination of technical trading signals. The bull-bear indicator 1150 might be used to provide guidance to more aggressive clients, who want to execute trades within seconds of a trading signal. Several of the trading guidance signal sets may be provided to the client simultaneously, as illustrated by the multitasking application access buttons 345, 1155, 1140, and 1165 on the taskbar 355.

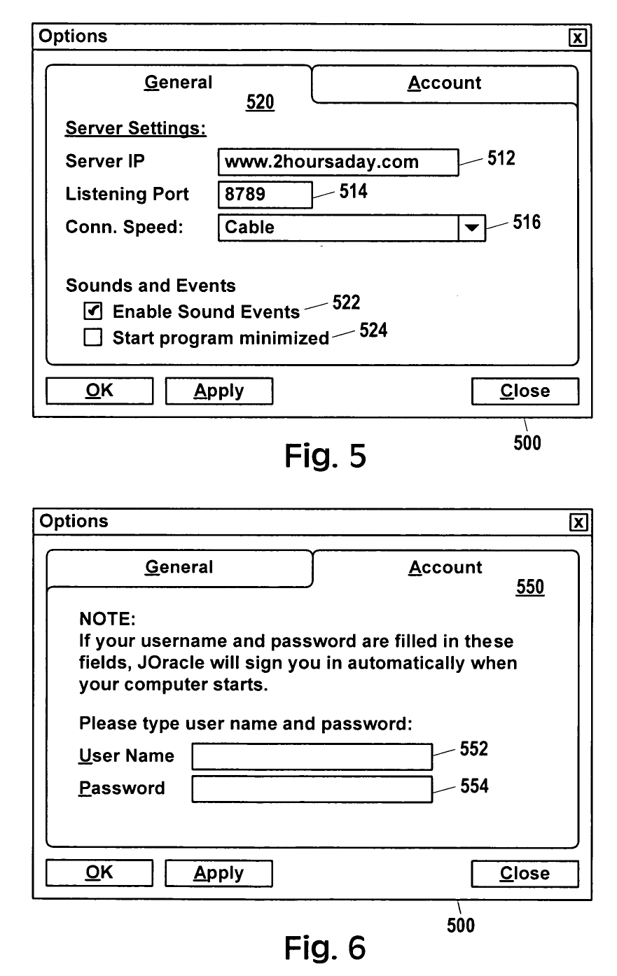

Turning back to the example of FIG. 3, the color-coded ball 320 presents a graphical user interface that is responsive to mouse actions. Clicking on the “options” button 330 opens an option window 500 (FIGS. 5 and 6) with a tab marked “general” 520 and a tab marked “account” 550. The “general” tab 520 enables the client to view and/or modify the server settings, such as the server IP address 512, the listening port 514, and connection type and/or speed settings 516. The “general” tab 520 also provides checkboxes 522 and 524 to enable the client to enable or disable sound events and specify whether the client software application 110 should start, upon boot up, in a minimized configuration. In a “minimized” configuration, no color coded ball 320 appears on the computer desktop display, but access to the client computer application 110 is instead provided through a button 345 on the taskbar 355. In a minimized configuration, the button 345 is preferably selectably configurable to take on the red, yellow, green, gray, and blinking representations that would otherwise be indicated by the color-coded ball 320.

Turning back to FIG. 1, the client software application 110 also preferably provides an instant messaging interface 116, in the form of a chat room interface, that enables a client to instantly communicate with the trader and/or with other of the trader's clients. The server/host software application 140 likewise includes a corresponding instant messaging interface 146 to enable the trader to communicate and manage the chat room.

To restrict access to the chat room, the client software application 110 preferably includes a logon module 112, and the server/host software application 140 includes a corresponding authentication module 142. To establish a connection, a user ID and password is entered, manually or automatically, into the logon module 112. The logon module 112 encrypts the user ID and password and sends a message through the network 120 to the server/host software application's authentication module 142. The authentication module 142 decrypts the user ID and password and compares the information with data stored in a user database 140. If there is a match, the authentication module 142 logs the client into the chat room. The authentication module 142 also records the date and time that clients log on and off and maintains a record in a journal 132.

Turning back to FIGS. 3 and 6, a client can log into the chat room in one of two ways. Right-clicking on the color-coded ball 320 causes a user control menu 340 to be displayed. The user control menu 340 provides menu options labeled “Log in” and “Log off” that enable the user to log in and off a chat session. Alternatively, the “account” tab 550 provides textboxes 552 and 554 that the client may fill with a user name and password. When filled in, the client computer application automatically logs the client into the session whenever the client computer application 110 is launched (as it is, for example, during the client computer's boot up sequence).

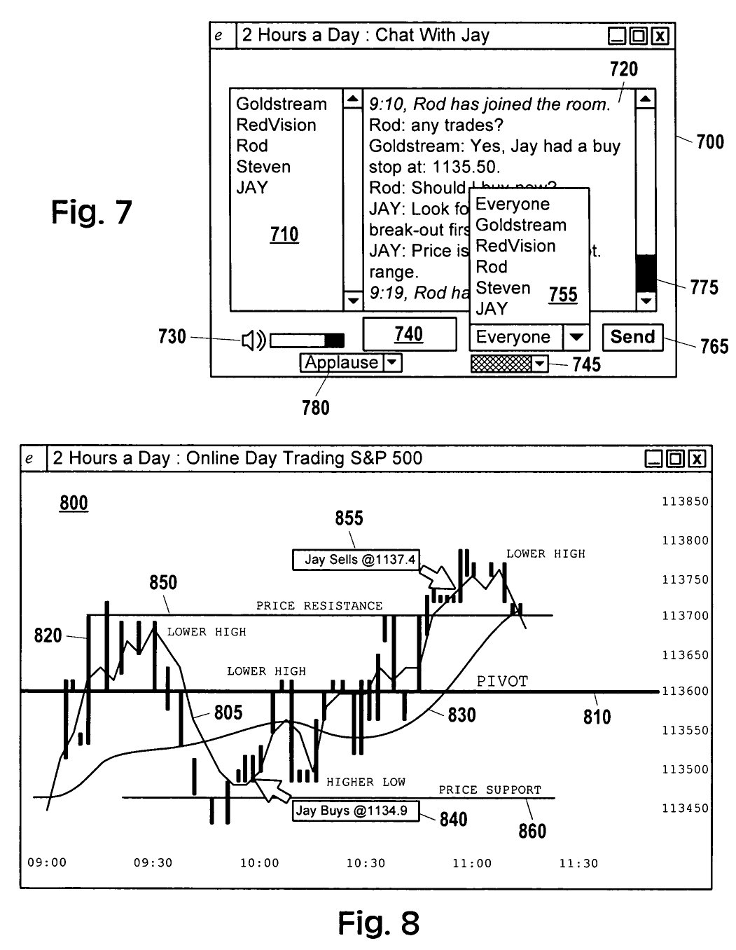

FIG. 7 illustrates one embodiment of an instant messaging or chat room interface 700 provided by the computer-based platform 100. The interface 700 includes a scrollable first window 710 that lists the chat room participants. The interface also includes a scrollable text stream window 720 that contains the contents of the day's chat room discussions. A scrollbar 775 enables the client or trader to review prior chat room discussions. An instant message entry text box 740 is provided to enter the text message, and a send button 765 to send the message. A font format selection menu 745 enables the client or trader to customize the format (e.g., color, type size, font type) of the text entered.

The interface 700 also preferably includes the ability to transmit sound information. A sound effect menu 780 enables the client or trader to broadcast a sound effect (such as applause, a splash, a celebratory exclamation, or the sound of a cash register) over the network to other chat room users. Traders and clients may mute the sound or adjust the volume of received sound effects through volume controller 730.

The interface 700 also provides both private and public messaging capabilities. Instant message recipient drop down list 755 enables a client or trader to direct a message to all chat participants or to a particular selected chat participant. Turning back to FIG. 3, an online status menu 360 enables a chat room participant (including the trader) to inform the server 155 and other chat room participants of activities that temporarily delay the participant from participating.

FIG. 10 illustrates one embodiment of a chat room administration interface 1000 that enables the trader to supervise the online discussion. The trader can open a chat room interface 700 by selecting the chat button 1020. A user list 1010 lists the chat room participants, their IP addresses, and their company. The trader can expel a participant from the chat room by selecting an “expel” option from a menu (not shown) caused by right-clicking on the participant's username. The trader can also permanently bar any participant originating from a given IP address by selecting a “block” option from the same menu. Preferably only the trader/administrator is given the capability of ejecting members from the chat room.

The server/host software application 140 also preferably includes a streaming voice interface 148 to enable the trader to send both public and private voice messages to clients. The client software application 110 includes a corresponding streaming voice interface 142 enabling the clients to receive the trader's voice messages, and optionally also to send voice messages to the trader and other online participants. FIG. 10 illustrates a talk button 1030 that switches on a microphone (not shown) connected to the trader's computer 165 and transmits the voice stream over the network 120 to the client computers 105. All of the online participants are able to orally communicate privately with each other or publicly with the whole group through their streaming voice interfaces 142. When the online participants speak publicly, their collective streaming voice interfaces 118 create a teleconference between them. The trader's streaming voice interface 148 preferably enables the trader to mute the other online participants individually or collectively.

Turning back to FIG. 1, the client software application 100 also preferably provides the client with a plurality of intraday and/or longer timeframe price fluctuation charts 122 together with customized technical analysis information supplied by the trader. These charts 122, when used in combination with the trade guidance signaling object 114, facilitate client education. FIG. 8 illustrates one embodiment of an intraday price fluctuation chart 800. A market data provider 180 (FIG. 1) provides the intraday price fluctuation data 805 and the charting platform. The presently preferred charting platform is the RealTick® platform marketed by Townsend Analytics, Ltd., of Chicago, Ill.

The chart 800 enables the trader to selectively display personally customized technical analysis information, such as red or blue candlesticks 820, a trend line 830, a pivot line 810, and price resistance and support lines 850 and 860. In one embodiment, the technical information is automatically generated using an algorithm customized by the trader. A routine (not shown) executed by the server/host software application 140 runs the algorithm on the incoming price fluctuation data and superimposes corresponding graphical information on the chart 800. In another embodiment, the trader subjectively generates technical commentary that is superimposed on the chart 800. For example, the server/host software application 140 might enable the trader to use a mouse to create and move a price support or resistance level line 860 or 850 on the chart 800, which information is broadcast through the network 120 so that it appears, in near-instantaneous fashion, on the trader's clients' charts. The server/host software application 140 also preferably enables the trader to add other indicators, such as time and price-mapped indicators 840 and 855 to broadcast when the trader or a client bought or sold a futures contract or other asset.

Preferably, the client software application 110 causes the intraday price fluctuation charts 122 to appear on the client's computer desktop display 300 whenever the client is logged in. In this manner, the client's charts 122 may run simultaneously with the client's trade guidance signaling device 114 and instant messaging interface 116, providing the client with a plurality of declarative, evaluative, and interactive interfaces to assist the client in learning the trader's market timing strategies.

Preferably, the trader's computer 165 also has an interface 170 for entering and executing a trade. In an optional embodiment, the server/host computer software application 140 automatically retrieves information identifying open (not yet executed) or closed (fully executed) trade orders made by the professional trader through the interface 170, and displays this information (or some portion of it) in the text message display box 325 of the client's color-coded ball 320. The server/host computer software application 114 retrieves this information directly from the interface 170 or through an intermediate medium, such as a file or cookie created by the interface 170.

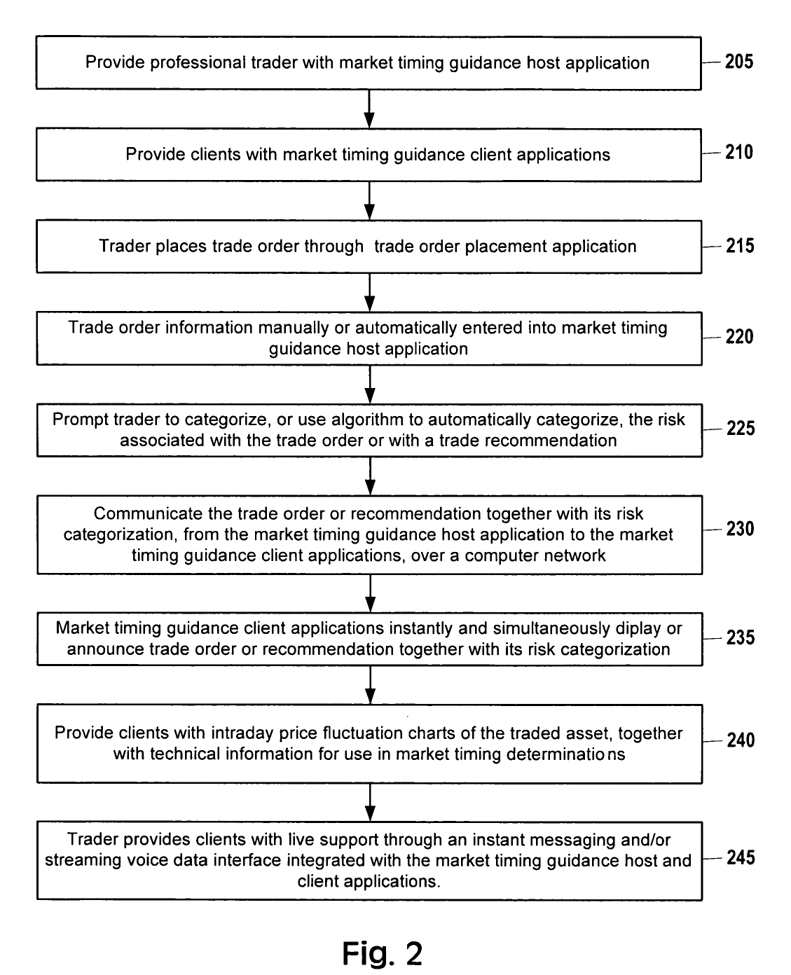

FIG. 2 is a flow chart of one embodiment of a method for providing a plurality of clients with market timing guidance. The progression of steps illustrated in FIG. 2 is not intended to limit the invention to methods that utilize more than or less than all of these steps or that perform one or more of these steps in a different order. In step 205, a professional trader obtains a market timing guidance host application. In step 210, the professional trader distributes market timing guidance host applications to each of his or her clients for installation on their personal computers. In step 215, the trader either identifies a recommendable trade activity, or actually places a trade, through a trade order placement application. In step 220, the trader, or an automated routine, enters the trade recommendation or order information into the market timing guidance host application. In step 225, the trader or a market-data-driven algorithm characterizes and categorizes the risk or attractiveness of the recommended or actual trade activity. In step 230, the recommended or actual trade activity is communicated from the market timing guidance host application to the market timing guidance client applications over a computer network. In step 235, the market timing guidance client applications instantly and simultaneously display or announce the recommended or actual trade activity together with a signal indicating its risk or attractiveness characterization. In step 240, the clients are also provided with intraday price fluctuation charts of the traded asset that include technical information for use in market timing determinations. In step 245, the trader provides clients with live support and guidance through instant messaging and streaming voice data interfaces that are integrated with the market timing guidance host and client applications.

Although not depicted in FIG. 1, the client computer software application 110 preferably includes embedded applications that automatically grab updated versions of the client computer software application 110 from the server 155 after the application 110 is shut down. It is also contemplated that the trade guidance signaling object 114 may be received by alternative devices, such as network-connected television monitors and other chosen reception devices.

Variations of the platform 100 described herein can be implemented using ordinary computer programming skills. Preferably, the platform 100 is built to include vendor-selectable limits on the number of concurrent users so that the platform 100 can be licensed on that basis.

Although the foregoing specific details describe various embodiments of the invention, persons reasonably skilled in the art will recognize that various changes may be made in the details of the apparatus of this invention without departing from the spirit and scope of the invention as defined in the appended claims. Therefore, it should be understood that, unless otherwise specified, this invention is not to be limited to the specific details shown and described herein.

I claim:

1. An apparatus enabling a trader to provide a plurality of clients with market timing guidance, the apparatus comprising:
a host computer software module that provides a set of predetermined and selectable buy and sell signals, the host computer software module enabling the trader to select one of said predetermined and selectable buy and sell signals to communicate a buy or sell recommendation on one or more assets to the plurality of clients; and
a computer software module for each of said plurality of clients, each client computer software module receiving the buy and sell recommendations from the host computer software module over a computer network; the plurality of client computer software modules simultaneously and instantly communicating the trader's selected buy and sell signals to said plurality of clients.

2. The apparatus of claim 1, wherein the host computer software module provides a set of no more than ten predetermined and selectable buy and sell signals.

3. The apparatus of claim 1, wherein the set of predetermined and selectable buy and sell signals comprises green and red colored buy and sell signals.

4. The apparatus of claim 1, wherein each client computer software module displays the trader's selected buy and sell signals with a windowless control that defines the display area.

5. The apparatus of claim 1, wherein the client computer software module displays the trader's selected buy and sell signals through a graphical user interface adapted to remain in the forefront of a computer desktop display when another computer application is active.

6. The apparatus of claim 1, wherein the client computer software module displays the trader's selected buy and sell signals through a semi-transparent graphical user interface adapted to remain in the forefront of a computer desktop display when another computer application is active.

7. The apparatus of claim 1, wherein each client computer software module provides intraday price fluctuation charts about the traded asset, whereby the combined display of intraday price fluctuation information of the asset together with the trader's selected buy and sell signals facilitates client education about the professional trader's market timing strategies.

8. The apparatus of claim 1, wherein the host computer software module and client computer software modules each include an instant messaging interface that enables the professional trader to send and receive instant messages to and from the clients.

9. The apparatus of claim 1, wherein the host computer software module and client computer software modules each include a streaming voice data interface that enables the professional trader to communicate voice messages to the clients.

10. An apparatus enabling a professional trader to provide a plurality of clients with market timing guidance, the apparatus comprising:
a host computer software module that provides a predetermined set of risk-categorized trading signals, the host computer software module communicating information identifying the professional trader's individual trades of an asset together with corresponding risk-categorized trading signals that characterize the risk of the professional trader's trades; and
a computer software module for each of said plurality of clients, each client computer software module receiving the trade information and corresponding risk-categorized trading signals from the host computer software module over a computer network; the plurality of client computer software modules simultaneously displaying the trade information and corresponding risk-categorized trading signals.

11. The apparatus of claim 10, wherein the client computer software module further comprises a window that displays intraday price fluctuation information about the traded asset, whereby the combined display of intraday price fluctuation information of the asset, information identifying day trader's individual trades of the asset, and trading signals that characterize the risk of the professional trader's trades facilitates efforts to educate the clients about the professional trader's market timing strategies.

12. The apparatus of claim 11, wherein the host computer software module and client computer software modules each include an instant messaging interface that enables the professional trader to send and receive instant messages to and from the clients.

13. The apparatus of claim 12, wherein the instant messaging interface enables the professional trader to send and receive both public and private instant messages to and from the clients.

14. The apparatus of claim 13, wherein the host computer software module and client computer software modules each include a streaming voice data interface that enables the professional trader to communicate orally with the clients.

15. The apparatus of claim 14, wherein the streaming voice data interface enables the professional trader to communicate privately with selected ones of said plurality of clients.

16. An asset-price analysis system comprising:
a computer application that communicates with an information network and displays first and second windows;
the first window comprising an instant messaging interface for sending and receiving messages from an analyst regarding the advisability of trading an asset; and
the second window providing intraday price fluctuation information about the asset;
wherein the computer application also displays one of a predetermined set of selectable signals that reflect the analyst's risk assessment of trading the asset.

17. The system of claim 16, wherein the predetermined set of selectable signals comprise color-coded objects whose colors characterize the risk of buying or selling the asset.

18. An asset-price analysis subscription system comprising:
a computer application that communicates with an information network and displays first, second, and third windows;
the first window comprising an instant messaging interface to enable an analyst to send messages regarding the advisability of trading an asset to a plurality of subscribers;
the second window providing the analyst with a predetermined set of selectable signals that represent a risk assessment of trading the asset, the second window enabling the analyst to select one of said selectable signals and instantly communicate said selected signal to the plurality of subscribers; and
a third window providing intraday price fluctuation chart information about the asset, the third window enabling the analyst to overlay said chart information with trade guidance signals, and to communicate said chart information, together with overlaid trade guidance signals, instantly to the plurality of subscribers.

19. A method for providing a plurality of clients with market timing guidance, the method comprising:
providing a professional trader with a host computer software module that includes a set of predetermined and selectable buy and sell signals;
providing each of said plurality of clients with client computer software modules operable to receive information from said host computer software module over a computer network;
enabling the trader, through said host computer software module, to select one of said predetermined and selectable buy and sell signals and communicate a buy or sell recommendation on one or more assets to the plurality of clients; and
communicating the selected one of said selectable buy and sell signals, together with said buy or sell recommendation, from the host computer software module to each of the client computer software modules;
wherein the client computer software modules simultaneously and near-instantaneously display the professional trader's buy and sell signals.

20. A method for providing a plurality of clients with market timing guidance, the method comprising:
providing a professional trader with an asset trading computer software module that enables the professional trader submit an order to trade an exchange-traded asset;
providing the professional trader with a host computer software module that automatically retrieves information identifying open or closed trade orders made by the professional trader through said asset trading computer software module;
wherein the host computer software module is operable to communicate a predetermined set of risk-categorized trading signals that characterize the risk of the professional trader's trades;
providing each of said plurality of clients with client computer software modules operable to receive information from said host computer software module over a computer network; and
communicating the information identifying open or closed trade orders made by the professional trader, together with corresponding risk-categorized trading signals that characterize the risk of the professional trader's open or closed trade orders, from the host computer software module to each of the client computer software modules;
wherein the client computer software modules simultaneously and nearly instantaneously display the professional trader's open or closed trade orders together with the corresponding risk-categorized trading signals.

21. The method of claim 20, further comprising the steps of:
providing each of said plurality of clients with a window that displays intraday price fluctuation information about the exchange-traded asset,
whereby the combined display of intraday price fluctuation information of the asset, information identifying day trader's open or closed trade orders of the asset, and trading signals that characterize the risk of the professional trader's trade orders facilitates efforts to educate the clients about the professional trader's market timing strategies.

22. The apparatus of claim 21, wherein the host computer software module and client computer software modules each include an instant messaging interface that enables the professional trader to send and receive instant messages to and from the clients.

23. The method of claim 22, wherein the host computer software module enables the professional trader to expel any client from an instant messaging session.

24. A method of providing a client with an advisor-assisted platform for monitoring intraday fluctuations in market prices of an asset, thereby assisting the client in making intraday trades, the method comprising:
providing the client with a computer software module that displays intraday price fluctuation information about the asset together with an instant messaging interface for sending and receiving messages to and from an advisor;
providing the advisor with a computer software module that displays intraday price fluctuation information about the same asset monitored by the client and provides the advisor with a messaging interface for sending and receiving messages to and from the client; and
streaming data about the price of an asset or index of assets to the client's and advisor's computer software modules.

25. A method of providing an advisor with a internet-connected computer software platform for assisting a plurality of subscribers on making trades, the method comprising:
providing the advisor with an instant messaging interface to enable an analyst to send messages regarding the advisability of trading an asset to a plurality of subscribers;
providing the advisor with a predetermined set of selectable signals that represent a risk assessment of trading the asset and enabling the advisor to select one of said selectable signals and instantly communicate said selected signal to the plurality of subscribers; and
providing the advisor with intraday price fluctuation chart information about the asset, and enabling the advisor to overlay said chart information with trade guidance signals, and to communicate said chart information, together with overlaid trade guidance signals, instantly to the plurality of subscribers,
wherein the information communicated through said instant messaging interface, selectable signals, and chart information are made available exclusively to authenticated subscribers.
